(19) United States
(12) Patent Application Publication
(10) Pub. No.: US 2010/0064311 A1
(43) Pub. Date: Mar. 11, 2010

(54) BD-Live Interface to the Distribution Supply Chain

(76) Inventor: Robin Ross Cooper, La Mesa, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/555,769

(22) Filed: Sep. 8, 2009

Related U.S. Application Data
(60) Provisional application No. 61/095,291, filed on Sep. 8, 2008.

(51) Int. Cl. H04N 7/025

(52) U.S. Cl. 725/36

(57) ABSTRACT

A method and device for the provision of enhanced media content distribution over a network. The method enables content providers, advertisers, and consumers to benefit from targeted advertising and promotions. The precise targeting for advertising and promotions are gleaned from consumer information provided by the system as to their geographic location which may be related to other known and mined information about the consumer.

This application claims priority to U.S. Provisional Patent Application No. 61/095291 filed Sep. 8, 2008 and which is incorporated herein in its entirety by reference.

### BACKGROUND OF THE INVENTION

1. Field

The disclosed invention relates to content distribution over a network. More particularly it relates to a Network connection between the Blu-Ray BD-Live portal and the greater distribution supply chain for physical media.

2. Background

The Blu-Ray format has arrived on the content distribution scene at a time when industry experts aren't sure what to do with it. In years past, physical media were simply items purchased through some type of retail distribution terminal such as a CD or DVD with a movie stored on it. At the start of the new decade, the electronic distribution of media via a global network, for media such as feature films has begun to take hold. Users of many cable television systems and satellite television systems are able to order and download media through their providers.

With the new standard for DVD distributed films and videos and the like, opportunities have also arisen for concurrent distribution of other media with the film or video itself. As this patent application will suggest, the old model of simply selling physical discs to consumers, without any value added features or functions, will not necessarily disrupt sales of the physical media. At the same time, the new on-line functionality of electronic media, such as BD-Live (the native on-line application for Blu-Ray) can serve to make the overall media experience much richer, as the full BD-Live experience is hard to deliver to the user through streams or downloads.

Since Blu-Ray, being physical media, requires a distribution supply chain of wholesalers and retailers to customers, the designing and building of systems which add value throughout the entire distribution supply chain can provide a significant increase in revenue and value to buyers and sellers in the chain. Such a system would not only benefit the content owners alone. Instead, by creating an end-to-end eco system that leverages the capabilities of Blu-Ray's BD-Live for the ultimate benefit of all stakeholders has great benefits to all concerned given the very long life that Blu-Ray has in front of it.

The disclosed device and method in this application describe a method of operation and network and resource management system for maximizing individual opportunities within Blu-Ray's BD-Live environment. The system herein overcomes the shortcomings of just offering a web portal operated by the content owners which disenfranchises the down-stream supply chain of wholesalers and retailers. The system herein also overcomes the shortcomings of simply providing a down-stream supply chain which offers incentives to consumers, without linking-in the content owners up-stream who need incentives to participate with the media content attracting consumers in the first place. Consequently, the deployment of the disclosed resource management system as presented in this patent application, which links the content owners with the down-stream supply chain and maximizes opportunities for all to profit through the provision of consumer incentives, offers the best possible outcome for all stakeholders.

With respect to the above, before explaining at least one preferred embodiment of the method and apparatus herein in detail or in general, it is to be understood that the method disclosed herein is not limited in its application to the details of construction and to the arrangement of the components or the steps set forth in the following description or illustrated in the drawings. The various methods and combinations of methods and/or apparatus of the disclosed invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods of operation and network and resource management systems for maximizing individual opportunities along the stream of commerce within Blu-Ray's BD-Live environment and the like, and for carrying out the several purposes of the present disclosed device and method. It is important, therefore, that the embodiments, objects and claims herein, be regarded as including such equivalent methodology and operational components insofar as they do not depart from the spirit and scope of the present invention.

Additionally, any trademarks used in this specification are for example only and employed because with well known trademarks, there is no other manner in which to describe the product in question. The various trademarks employed within this specification are the property of their respective owners.

### SUMMARY OF THE INVENTION

In the current state-of-the-art network architecture for BD-Live when used with a Blu-Ray standard on a player connected to a television set, there are conventional connection mechanisms and facilities and formats such as HDMI. If the Blu-Ray Player and recorder is able to make a network connection by way of a land based, network, or wireless connection, the software authored for the Blu-Ray disc will instruct the Blu-Ray Player to make a network connection by way of the Open Internet so the BD-Live portal service operated by the content owner can be accessed by the consumer. Once this network connection is made, the consumer can use the various features and functions offered on the BD-Live service to further the overall entertainment experience.

It should be noted that not all Blu-Ray Player units can make a network connection and only the Blu-Ray units designated as profile 2 devices can make such a network connection. However, as technology advances yearly, it is anticipated that virtually all Blu-Ray players in the future will be built to offer a network connection within the scope of this patent.

In the high level system architecture there are two additional server systems. One server system is dedicated to provide network services and applications to the Distribution Partner. The second server system is dedicated to provide network services and applications to the Content Owner. Although in an alternative embodiment one server system can be used that will perform all functions required by both the Distribution partner and the Content owner, such a two-server model more easily describes how this model can scale.

In the system a single Distribution Partner is responsible to provide the Blu-Ray disc to the consumer for purchase or as a rental in operation of the Distribution Server System. When the consumer takes the Blu-Ray disc and places it into the Blu-Ray Player to play, and selects a BD-Live application or service, then the Distribution Partner can participate along with the Content Owner by way of the primary BD-Live site. In the system, the Content Owner is connected to a dedicated server system that will execute the necessary functions and procedures designed to maximize the consumer's experience and ultimately sell more units.

In a fundamental purpose of the system as it facilitates the passing of relevant information from one end of the Blu-Ray supply chain to the other, the downstream supply chain is populated with entities that handle the physical distribution functions including but not limited to distributors such as retail facilities, web portals with physical media delivered by way of the postal service or other types of courier services.

Within this end-to-end supply chain, opportunities abound for maximizing the unique vantage point of each distribution partner. As such, the networked system architecture as envisioned in operation in this disclosure will allow the downstream distribution partners to post information, incentive programs and other useful data on BD-Live portal sites operated by Content Owners. Additionally, the Content Owners may employ electronic means to coordinate meaningful campaigns for national (or international) advertisers that use the Distribution Partner's infrastructure to carry out the necessary consumer-facing functions.

In a typical BD-Live portal site all Content Owners will have at least one prominent place for advertising. A novel addition herein, is that a secondary space where local ads can be prominently placed as well. Both of these ad spaces can then be coordinated in such a way as to further compel the consumer to action. For example, a national advertiser such as COCA-COLA can partner with a local pizza shop to whom they sell drinks, in order to provide a compelling incentive to the consumer. Additional utility of the system allows for the coordination of COCA-COLA and a local pizza shop to advertise to consumers who fit a specific profile. Other consumers may see different coordinated advertising campaigns with different advertisers and local establishments based on their own profiles, for example the coordination of a STARBUCKS and a local pastry shop.

In a typical campaign COCA-COLA will be providing the consumer an opportunity to receive a free drink and a movie rental when a pizza is purchased from Joe's, a local vendor. In this fashion COCA-COLA company has a facility and a supply chain to provide a valuable incentive to a consumer, or population of consumers, leveraging the ability to electronically connect with the Content Owner, the pizza restaurant, and the local video shop located in the neighborhood of the consumer by way of the BD-Live site. The Content Owner now has a facility and a supply chain to deliver their free movie to the consumer as part of a larger campaign they have arranged with Coka-Cola. The Local Advertiser now has the opportunity to electronically partner with COCA-COLA in such a way as to further increase his own brand visibility and offer the consumer a highly compelling package within a potentially competitive local market. Finally, other local vendors and retailers can also benefit from such a system as they will be needed to facilitate the delivery of the products and services. For example, the local video shop may be needed to distribute the free movie. The local video shop may also redeem the coupons as presented by the consumers.

The system herein is scalable in that it allows a single Content Owner to connect with the various distribution partners for two purposes. First, they enjoy an economy of scale as the processes created for one Distribution Partner can be equally beneficial to other Distribution Partners as well. Second, they have the ability to allow advertisers and other partners the ability to connect with more consumers. The system architecture can be achieved using one server, or a server farm, allowing an application service to provide all necessary network connections, applications, and services.

One advantage of Blu-Ray mode is the individual discs can be imprinted with a unique ID Number that can be identified once a consumer logs on to a BD-Live site. Although it may be virtually impossible to know who the consumer is, it is a relatively simple thing to know the disc was purchased by a video rental chain.

In addition, state-of-the-art geo filtering and location awareness systems, mechanisms and processes can be used to further identify the status of the consumer. The linking of these disparate components, using the ID Number of the disc, location awareness, geo filtering, and the linking to the CRM, can then be used to effectively target advertisements and campaigns in such a way as to provide an excellent user experience for the end consumer and ultimately better results for all other stakeholders as well.

As confidentiality is important, the identity of the consumer can be protected. For example, VideoEZY may provide information to COCA-COLA regarding a certain customer using a specific Blu-Ray disc. COCA-COLA may learn this consumer is a college student living in a dormitory at a major university in Sydney, Australia. COCA-COLA may also learn this customer prefers action movies to all others. In a preferred embodiment, the identity of this customer will be fiercely protected and an advertiser should never know this customer's name or physical address. Other steps can also be taken to further protect the consumer's privacy and confidentiality.

The BD-Live website accessed by the consumer can be altered to provide additional levels of relevancy and value to all stakeholders. When the consumer logs-on to the BD-Live site, it is possible to change the “look and feel” of the user interface or the “skin,” in order to intelligently provide the appropriate context to the consumer based on the uncovered consumer information noted above.

The system and method herein is dependent on the distribution and redemption of incentives, sometimes referred to as coupons. Since highly valuable and effective advertising campaigns are coupled to incentive programs, this system will contain a very powerful, state-of-the-art incentive distribution or redemption system.

In the disclosed Incentive Distribution System the advertiser will be able to obtain information about a base of consumers and prepare an advertising/incentive campaign believed to be highly effective. Once this campaign has been crafted, that Advertiser will be able to order the advertisements along with single (or multiple) incentives for each identified consumer based on their individual information.

Conventionally, the redemption of incentives has been an annoying and laborious process and yields little except the approximate amount the advertiser needs to pay for a certain campaign. Employing the method herein and apparatus, the data derived from incentive programs is rich with specific information that has the potential to be enormously valuable to the various stakeholders in the chain as well as to the consumer due to more targeted incentives.

Such a system as disclosed herein, allows not only the Content Owners the ability to aggregate and organize data via the Content Owner-Side Server, the Content Owners can additionally aggregate and organize data across numerous platforms and distribution partners. Therefore, an Advertiser may order Ads+Incentives that are distributed across numerous disparate systems.

In a preferred embodiment herein, the revenue generated from Advertisers as they use this system will be shared in such a way as to provide adequate incentives for the entire distribution supply chain. Content Owners can enjoy revenues derived from advertising sales collected from local advertisers and Retailers can enjoy revenues derived from advertising sales collected from national and international advertisers. Such a revenue sharing model will additionally help provide a means to promote the adoption of such a system as new and significant revenues can be generated for the major stakeholders.

In use, when consumer-level data is being collected and transmitted “upstream” to the BD-Live portal, it is possible for the MAC Address of the Blu-Ray player unit (or other unique identifier) to be transferred with the data as well. The purpose of the transfer of this MAC Address information is to better understand what activities and offerings a consumer is enjoying from another Content Owner. By capturing the MAC Address of the device, information across numerous BD-Live sites can be aggregated and organized to further add value to advertisers looking to carefully target their Ad and Incentive programs.

Both Distributors and Content Owners are able to share Databases with their peers in order to gain more access to valuable data about consumers. This will in turn provide more and better data for the targeted advertising opportunities over Blu-Ray.

The foregoing has outlined some of the more pertinent objects and general operating principles of the method and apparatus herein. These should be construed to be merely illustrative of some of the more prominent features and applications of the intended invention. Many other beneficial results can be attained by applying the disclosed method and and apparatus herein in a different manner or by modifying the invention within the scope of this disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated herein and form a part of this specification, illustrate embodiments of the invention and together with the detailed description, serve to explain the principles of this invention.

FIG. 1 describes the current state-of-the-art network architecture for BD-Live.

FIG. 2 describes the High-Level System Architecture

FIG. 3 describes the fundamental purpose of the system as it facilitates the passing of relevant information from one end of the Blu-Ray supply chain to the other.

FIG. 4 provides an example of how the system might look on the BD-Live portal site.

FIG. 5 shows how one specific campaign might look.

FIG. 6 further helps describe how the various partners and stakeholders can coordinate and synchronize their efforts

FIG. 7 describes a model that allows a single Content Owner to connect with the various distribution partners.

FIG. 8 shows a Distribution Cooperative model.

FIG. 9 describes how the BD-Live site can be altered to provide addition levels of relevancy.

FIG. 10 shows a High-Level picture of the system including the major system components.

FIG. 11 describes this Incentive Distribution System at a high level.

FIG. 12 describes a method for both Distributors and Content Owners to share Databases with their peers.

FIG. 13 shows an example graphical user interface for a system management application that will allow advertisers to load and manage advertisements and incentive programs.

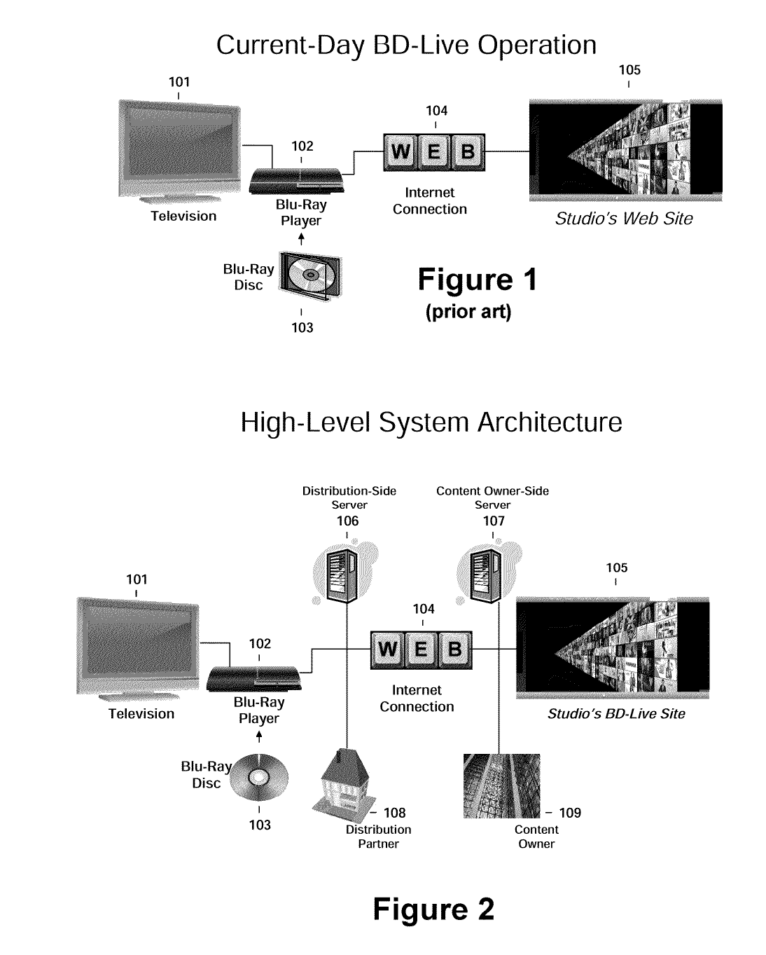

### DETAILED DESCRIPTIONS OF THE PREFERRED EMBODIMENTS OF THE INVENTION

Referring now to the drawings, wherein similar parts of the invention are identified by like reference numerals, there is seen and described the current state-of-the-art network architecture for BD-Live.

As can be discerned, the Blu-Ray player (102) is connected to the Television set (101) using standard connection mechanisms and facilities (including but not limited to HDMI). If the Blu-Ray Player (102) is able to make a network connection by way of a landline or wireless connection, then the software authored on to the Blu-Ray disc (103) will instruct the Blu-Ray Player (102) to make a network connection by way of the Open Internet (104) so the BD-Live portal service (105) operated by the content owner can be accessed by the consumer. Once this network connection is made, the consumer can use the various features and functions offered on the BD-Live service (105) to further the overall entertainment experience.

It should be noted that not all Blu-Ray Player units can make a network connection. At the time of this writing, only the Blu-Ray units designated as “Profile 2” devices can make such a network connection. It is anticipated that virtually all Blu-Ray players in the future will be built to offer such a (Profile 2) network connection or greater.

FIG. 2 describes the High-Level System Architecture. As and be seen, there are two additional server systems. One server system is dedicated to provide network services and applications to the Distribution Partner (106). The other server system is dedicated to provide network services and applications to the Content Owner(s) (107). Although in an alternative embodiment one server system can be used that will perform all functions required by both the Distribution partner and the Content owner(s), such a two-server model will best describe how this model can scale (as new distribution partners are added). A single Distribution Partner (108) is presented in FIG. 2. This Distribution Partner (108) is responsible to provide the Blu-Ray disc to the consumer (for purchase or rental) and operate the Distribution Server System (106). When the consumer takes the Blu-Ray disc (103) and places it into the Blu-Ray Player (102) and selects a BD-Live application or service, then the Distribution Partner can participate along with the Content Owner by way of the primary BD-Live site (105). Finally, the Content Owner (109) is connected to a dedicated server system that will execute the necessary functions and procedures designed to maximize the consumer's experience and ultimately sell more units.

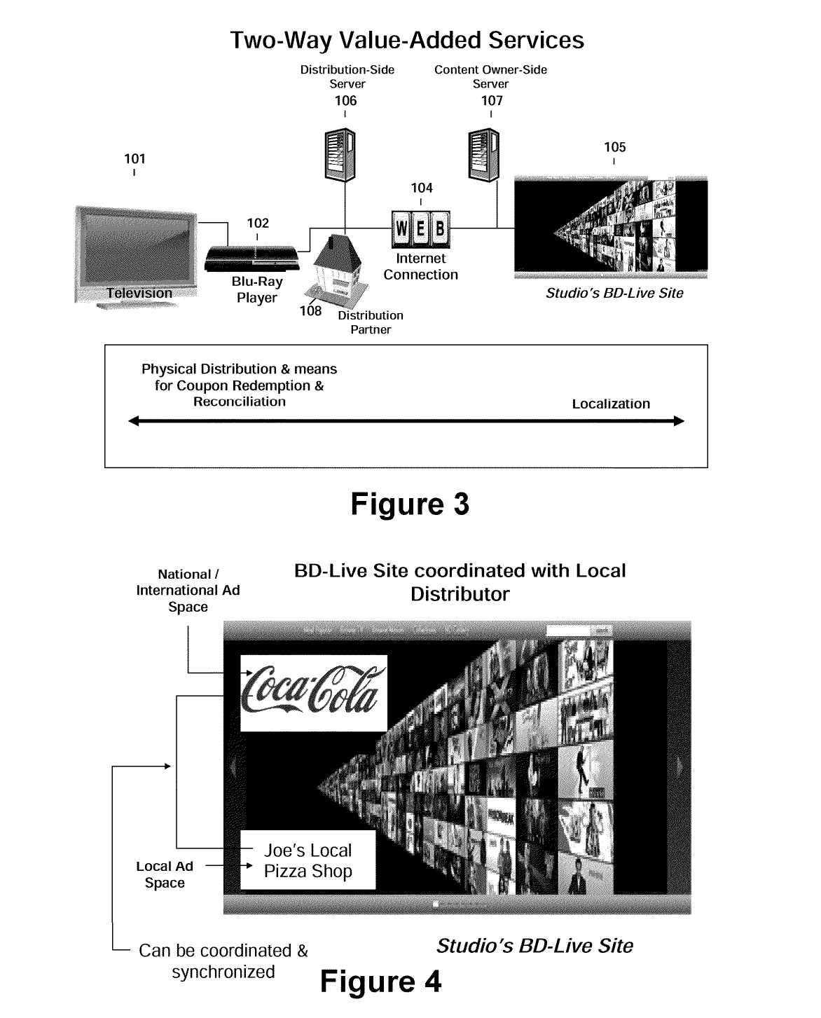

FIG. 3 describes the fundamental purpose of the system as it facilitates the passing of relevant information from one end of the Blu-Ray supply chain to the other. As mentioned above, the downstream supply chain is populated with entities that handle the physical distribution functions including but not limited to:
Retail facilities (rental or purchase)
Web portals with physical media delivered by way of the postal service or other types of courier services.
Other venues where physical media are distributed.

Within this end-to-end supply chain, opportunities abound for maximizing the unique vantage point of each distribution partner. Therefore, the networked system architecture as defined in this patent application will:
Allow the downstream distribution partners to post information, incentive programs and other useful data on BD-Live portal sites operated by Content Owners.
Allow Content Owners to use electronic means to coordinate meaningful campaigns for national (or international) advertisers that use the Distribution Partner's infrastructure to carry out the necessary consumer-facing functions.

FIG. 4 provides an example of how the system might look on the BD-Live portal site. It is obvious that all Content Owners will have at least one prominent place for advertising. A novel addition is a secondary space where local ads can be prominently placed as well. Both ad spaces can then be coordinated in such a way as to further compel the consumer to action. For example, COCA-COLA can partner with a local pizza shop in order to provide a compelling incentive to the consumer.

It should be noted, to take matters one step further, the coordination of COCA-COLA and a local pizza shop can be performed for consumers who fit a specific profile. Other consumers may see different coordinated advertising campaigns based on their own profiles (for example the coordination a Starbucks and a pastry shop.)

FIG. 5 shows how one specific campaign might look. In this example, COCA-COLA will be providing the consumer an opportunity to receive a free Coke and a movie rental when a pizza is purchased from Joe's. The following results have now been achieved:
COCA-COLA has a facility and a supply chain to provide a valuable incentive to a consumer (or population of consumers) leveraging the ability to electronically connect with the Content Owner, the pizza restaurant, and the local video shop located in the neighborhood of the consumer by way of the BD-Live site.
The Content Owner now has a facility and a supply chain to deliver their free movie to the consumer as part of a larger campaign they have arranged with COCA-COLA.
The Local Advertiser now has the opportunity to electronically partner with COCA-COLA in such a way as to further increase his own brand visibility and offer the consumer a highly compelling package (within a potentially competitive local market).
Other local vendors and retailers can also benefit from such a system as they will be needed to facilitate the delivery of the products and/or services. For example, the local video shop (or distribution platform) will be needed to distribute the free movie. The local video shop may also redeem the coupons as presented by the consumers.

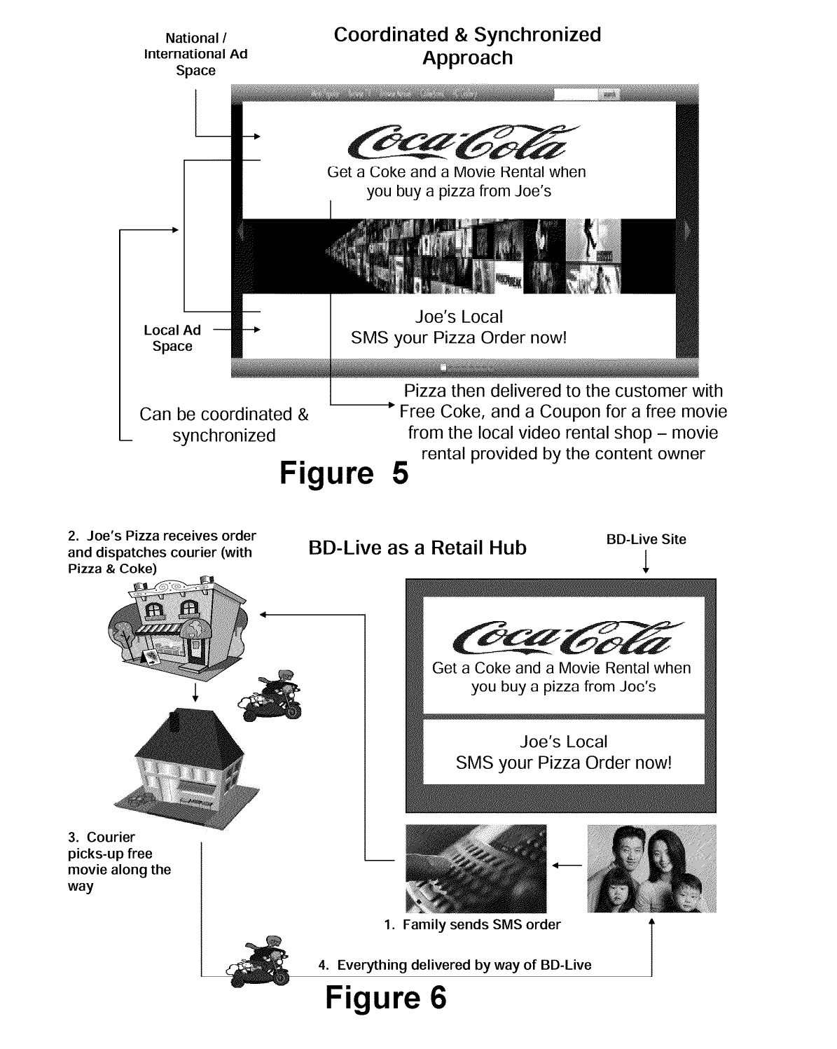

FIG. 6 further helps describe how the various partners and stakeholders can coordinate and synchronize their efforts in order to offer consumers a highly compelling experience. Displayed in this figure is the instruction for a family to send an SMS message in order to get a package of goods and incentives. If the family sends the SMS, then all goods and services are delivered with the BD-Live site acting as the hub for the entire experience.

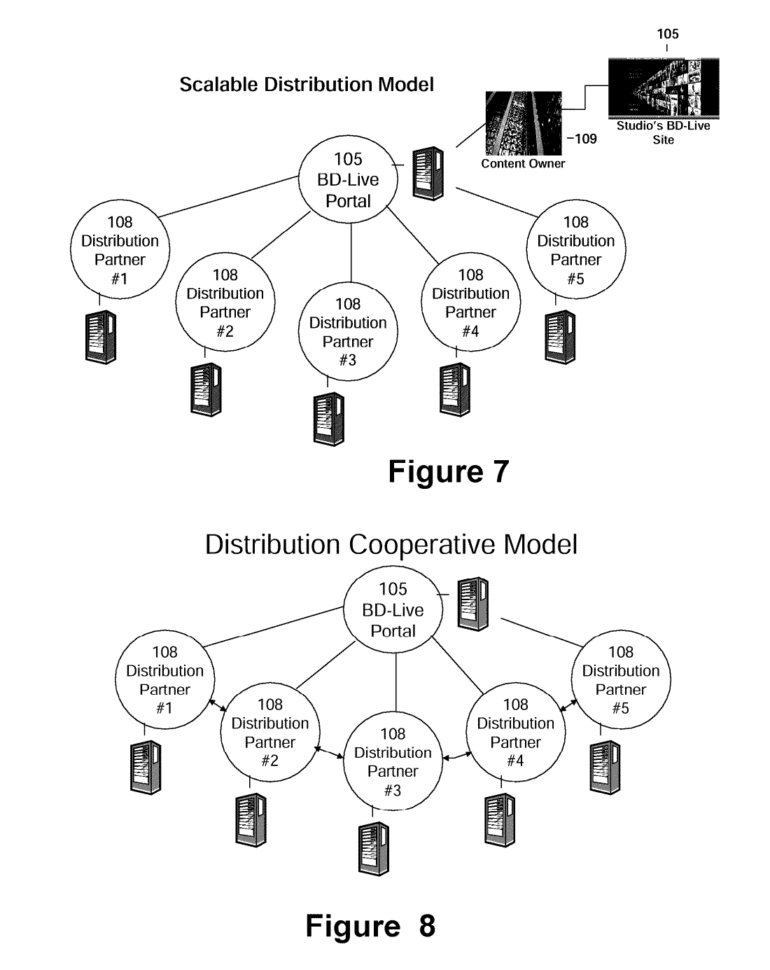

FIG. 7 describes a model that allows a single Content Owner to connect with the various distribution partners for two purposes as follows:
To enjoy an economy of scale as the processes created for one Distribution Partner can be equally beneficial to other Distribution Partners as well.
To allow advertisers and other partners the ability to connect with more consumers.

Once again as mentioned above, the system architecture can be achieved using one server (or a server farm) allowing an application service to provide all necessary network connections, applications, and services.

FIG. 8 shows a Distribution Cooperative model where the various Distribution Partners can be connected in such a way as to provide coordinated (higher-value) incentives and offerings to consumers.

One advantage of Blu-Ray is the individual discs can be imprinted with a unique ID Number that can be identified once a consumer logs on to a BD-Live site. Although it may be virtually impossible to know who the consumer is, it is a relatively simple thing to know the disc belongs to a video rental chain and the consumer is renting (or has purchased) the disc from this video rental chain.

In addition, state-of-the-art geo filtering and location awareness systems, mechanisms and processes can be used to further identify the status of the consumer. For example, a disc can be identified as one being sold to the VideoEZY chain in Australia. The geofiltering mechanisms that are deployed indicate the consumer is logging-on to the BD-Live site from within Australia. Therefore, we assume this consumer is truly a VideoEZY customer living somewhere in Australia. If VideoEZY then took the appropriate steps to link these ID Numbers to the VideoEZY customer ID numbers (by way of a bar code scanner or similar device), then VideoEZY could then access their own Customer Resource Management System (CRM) and provide the profile information “upstream” to other stakeholders.

The linking of these disparate components (using the ID Number of the disc, location awareness, geo filtering, and the linking to the CRM) can then be used to effectively target advertisements and campaigns in such a way as to provide an excellent user experience for the end consumer and ultimately better results for all other stakeholders as well. Geo filtering can be as simple as inspecting the IP Address for its origin somewhere on the planet.

It is important to note that although a CRM system can be accessed, the identity of the consumer can (and should) be protected. For example, VideoEZY may provide information to COCA-COLA regarding a certain customer using a specific Blu-Ray disc. COCA-COLA may learn this consumer a college student living in a dormitory at a major university in Sydney, Australia. COCA-COLA may also learn this customer prefers action movies to all others. In a preferred embodiment, the identity of this customer will be fiercely protected and, therefore, COCA-COLA should never know this customer's name or physical address. Other steps can also be taken to further protect the consumer's privacy and confidentiality.

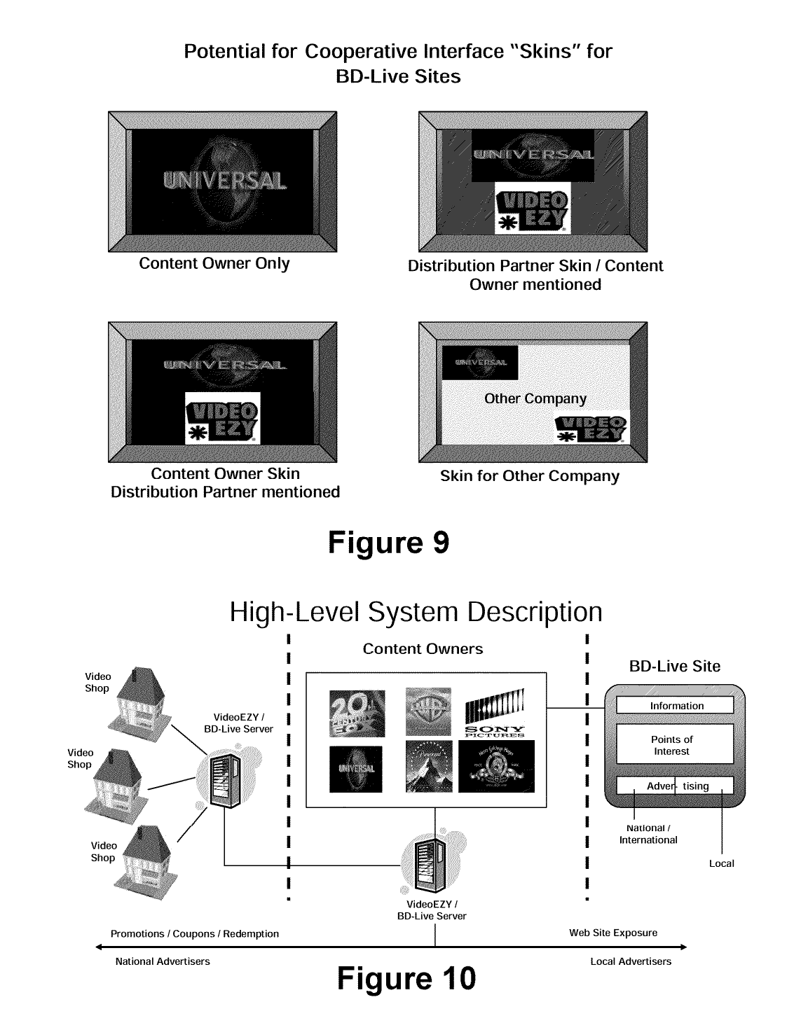

FIG. 9 describes how the BD-Live site can be altered to provide additional levels of relevancy and value to all stakeholders. When the consumer logs-on to the BD-Live site, it is possible to change the “look and feel” of the user interface (or the “skin”) in order to intelligently provide the appropriate context to the consumer. For example, if a consumer rents a Blu-Ray disc from VideoEZY and logs on to the BD-Live site, it may be beneficial to change the “look and feel” of the web site in order to improve the overall experience.

Just as skins can be altered on the BD-Live site (as a result of knowing the various Distribution Partners and including them in the user's experience), other context relevant information, services, applications can be offered to the consumer. For example, links to other web sites and web-based facilities can be made available to consumers as long as these links belong to legitimate participants within the distribution supply chain. For example, if a consumer purchases a Blu-Ray disc from Walmart in the United States, then a link to the Walmart website may appear on the BD-Live site. Automatic re-direction can also occur (as long as such re-direction is approved by the Content Owners). It is then possible for the consumer to see a completely different web site (other than the Content Owner's BD-Live site) if the consumer falls into such a pre-defined category.

FIG. 10 shows a High-Level picture of the system including the major system components.

The system presented in this patent application is heavily dependent on the distribution and redemption of incentives, sometimes referred to as coupons. Since highly valuable and effective advertising campaigns are coupled to incentive programs, this system will contain a very powerful, state-of-the-art incentive distribution/redemption system.

It should be noted that this disclosure avoids the use of the word “Coupon,” as a coupon is typically referred to as a piece of paper distributed to consumers in some enormously inefficient manner. In the system as described in this patent application, these incentives are typically not pieces of paper and the means for distribution can be extra-ordinarily efficient.

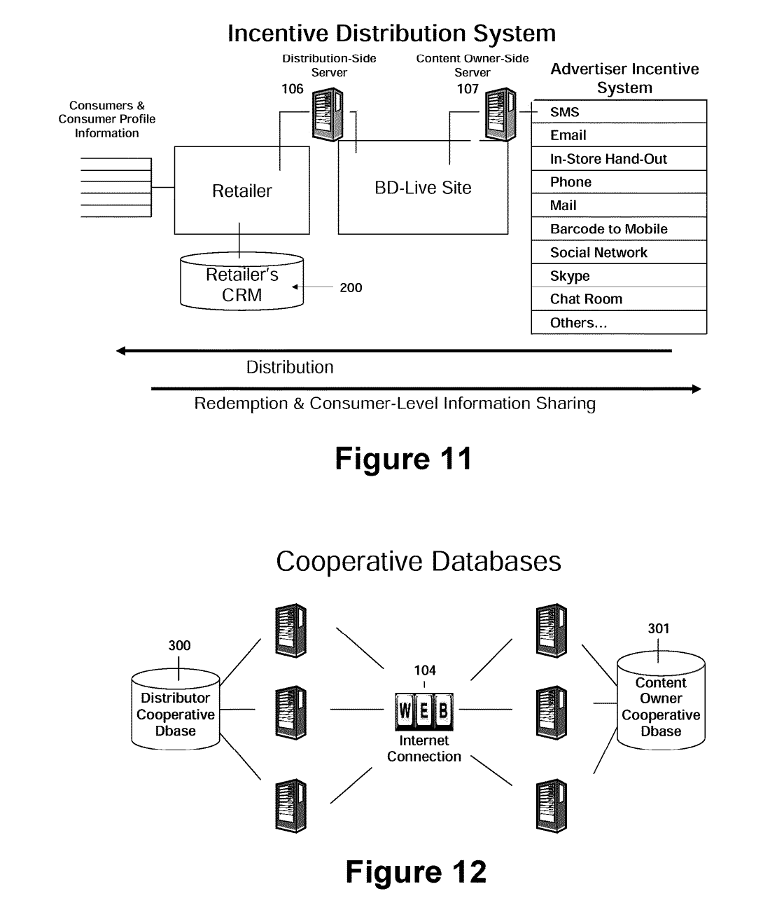

FIG. 11 describes this Incentive Distribution System at a high level. The advertiser will be able to obtain information about a base of consumers and prepare an advertising/incentive campaign believed to be highly effective. Once this campaign has been crafted, the Advertiser will be able to order the advertisements along with single (or multiple) incentives as exemplified within the figure. As presented in FIG. 11, the examples of incentive programs are:
SMS
Email
In-Store Handout
Phone
Mail
Bar Code to Mobile Device
Posting to a Social Network (belonging to the target consumers)
Skype (VoIP) Delivery
Chat Room Delivery
Other forms of Incentive Delivery

FIG. 11 also depicts how the Advertisers will receive information regarding the redemption of the incentives back from the field.

The redemption of incentives has traditionally been an annoying and laborious process that typically yields little except the approximate amount the advertiser needs to pay for a certain campaign. Looking forward as new targeted advertising methods, processes, and systems are being created, the data derived from incentive programs is rich with specific information that has the potential to be enormously valuable to the various stakeholders.

The following conventional steps for handling incentives typically occur with coupons:
1. Consumer “clips” a coupon from the Sunday newspaper
2. Consumer provides incentive documentation to a retailer
3. Retailer provides consumer with goods and/or services and uses the documentation to appropriately determine all monies owed
4. Retailer manually enters coupon data into a simple application program (possibly a spreadsheet) containing the following fields:
   a. Date
   b. Time
   c. Retailer's ID
   d. Redemption Location
   e. Amount
   f. Consumer ID (if one exists)
   g. Other similar fields.

Once this data has been entered, a sum total is derived and the advertiser is asked to pay the specified amount. In some cases, this data can be transferred to the advertiser, however, it is often useless as the advertiser has no capacity to make any further evaluations or determinations.

In contrast, the Incentive Redemption described herein operates as follows:

1. Consumer-Level data is transmitted to the advertiser with detailed information regarding the profiles of individual consumers and how these consumers tend to be clustered into meaningful groups.

2. The advertising personnel for a company (often with the help of advertising agencies and counterparts) can then craft advertising campaigns which are designed to maximize the consumer-level data they received.

3. The incentive programs are ordered using a user-friendly interface most likely using the metaphor of a shopping cart. The Advertiser can order anything from a shot-gun style ad+incentive, or the Advertiser can opt for virtually any level of targeting desired.

4. The instructions for the ad+incentive campaign are then transmitted to the Content Owner by way of the Content Owner-Side Server (107). The Content Owner-Side Server (107) then sends this same data to each of the Distribution-Side Servers (106) that have been targeted by the Advertiser.

5. When the consumer places a Blu-Ray disc into a Blu-Ray profile 2 (or greater) player, and then initiates a BD-Live session, then the advertisements and incentives will be delivered as instructed by the advertiser.

6. In a preferred embodiment, virtually all incentives will contain some type of barcode if not a near-field technology that will allow for fast and easy scanning once the incentives have been redeemed by the consumers. The scanning of these electronically encoded incentives will yield a data base that looks more like the following:
a. Date
b. Time
c. Retailer's ID
d. Redemption Location
e. Amount
f. Consumer ID (if one exists)
g. Profile of Consumer
h. Consumer's Other Purchases (known to the Retailer) at that time
I. Consumer's Past Purchases
j. Consumer's Buddies, Associates, Colleagues, etc.
k. Redemption of other incentives from same advertiser
l. Redemption of other incentives from different advertisers
m. Device used to redeem incentive (if redeemed using electronic means)
n. Any and all other information that can be meaningful.

Once this data is collected, the Distribution-Side Server (106) will organize and catalog this information in such a way as new and highly effective advertising/incentive programs can be crafted and executed in the future. The Advertiser can then receive the data in a format that is well organized fore future campaigns.

A more in-depth description of how the Ad+Incentive process will work including the redemption of the Incentive is as follows:

Using the example from FIG. 6, a family places a Blu-Ray disc into the Blu-Ray player (profile 2 or greater) and opts to use BD-Live. Once the system connects to the BD-Live site provided by the content owner, the family is presented with a relevant Ad and at that moment the head of the household receives an SMS message on his or her mobile device.

Note: This SMS message was sent as a result of the request made by the Advertiser to do so within the set of conditions that exist. The Distribution-Side Server (106) was responsible to send the SMS as it is connected to the CRM system (200 as described in FIG. 11).

The SMS message indicates the consumer only needs to reply to the SMS and a Pizza, Coke, and free movie will be delivered to the home within a specified number of minutes.

In our scenario, the consumer replies to the SMS and receives the Pizza, Coke, and free movie as promised.

Later, the courier goes on-line to the Distribution-Side Server (106) and indicates the delivery was successful. The Distribution-Side Server will then package all possible data elements regarding these consumers and their household, and transfer this data back to the Content Owner-Side Server (107) so the Advertiser can be appropriately billed. The Advertiser will then be able to purchase some or all of the consumer-level data collected if desired.

Such a system as defined in this disclosure allows the retailer to aggregate and organize consumer-level data through its Distribution-Side Server (106). Such a compilation of data can be enormously valuable to local advertisers and others looking to monetize its relationship to the retailer. Such a system as defined in this disclosure also allows not only the Content Owners the ability to aggregate and organize data via the Content Owner-Side Server (107), the Content Owners can additionally aggregate and organize data across numerous platforms and distribution partners. Therefore, an Advertiser may order Ads +Incentives that are distributed across numerous disparate systems. It is common for advertisers to desire a large “reach” sometimes referred to as “eye-balls” rather than focusing on one retailer only. Therefore, this ability to aggregate and organize cross-platform data can be extremely important for wide-spread adoption.

In a preferred embodiment of the system herein, the revenue generated from Advertisers as they use this system will be shared in such a way as to provide adequate incentives for the entire distribution supply chain. Content Owners can enjoy revenues derived from advertising sales collected from local advertisers. Retailers can enjoy revenues derived from advertising sales collected from national and international advertisers. Such a revenue sharing model will additionally help to promote the adoption of such a system as new and significant revenues can be generated for the major stakeholders.

When consumer-level data is being collected and transmitted “upstream” to the BD-Live portal, it is possible for the MAC Address of the Blu-Ray player unit (or other unique identifier) to be transferred with the data as well. The purpose of the transfer of this MAC Address information is to better understand what activities and offerings a consumer is enjoying from another Content Owner. By capturing the MAC Address of the device, information across numerous BD-Live sites can be aggregated and organized to further add value to advertisers looking to carefully target their Ad and Incentive programs.

As mentioned above, the preferred embodiment of this application is for the consumer's privacy and confidentiality to be protected. Therefore, sending the MAC Address as described above may pose a problem (or threat) to the consumer. One solution is for a third-party proxy provider to sanitize the MAC Address by substituting the actual MAC Address for a substitute ID Number. Although “upstream” stakeholders will not know the identity of the consumer, the consumer's Blu-Ray player can be addressed by reversing the process (and going “downstream” through the proxy provider's service once again).

FIG. 12 describes a method for both Distributors and Content Owners to share Databases with their peers in order to gain more access to valuable data that will, in turn, provide more and better data for targeted advertising opportunities over Blu-Ray. Distributors can cooperate with one another to share valuable consumer-level data by way of the Distributor Cooperative Database (300). Likewise, Content Owners can also cooperate with one another to share valuable consumer level data and Distributor data by way of the Content Owner Cooperative Database (301).

It should be noted that it is unlikely the content owners will provide the resources for their own BD-Live portal sites. Instead, they will most likely outsource these functions to sufficiently capable vendors and/or suppliers.

Although software libraries can be created and delivered to the various authoring houses known to author Blu-Ray discs, it is the preferred embodiment for this patent application that the entities engaged to operate such a service for the Content Owners also engage themselves in the authoring process itself. The primary reason for this is the amount of coding, debugging, and upgrading that needs to take place over time. The delivery of software code to outside organizations may be cumbersome, difficult, and resistant to important upgrades and improvements.

Content Owners frequently make the observation that there are no ‘R&D’ houses. Their meaning being, they are typically not commissioned with the task of writing or maintaining software code or networked systems. An Applications Service Provider (ASP) may be well suited to perform the applications, services, and functions described in this patent application.

Similar to the Content Owners, the Distributors may wish to outsource the applications, services, and functions described in this patent application as well. An Applications Service Provider (ASP) may, therefore, serve as an excellent partner.

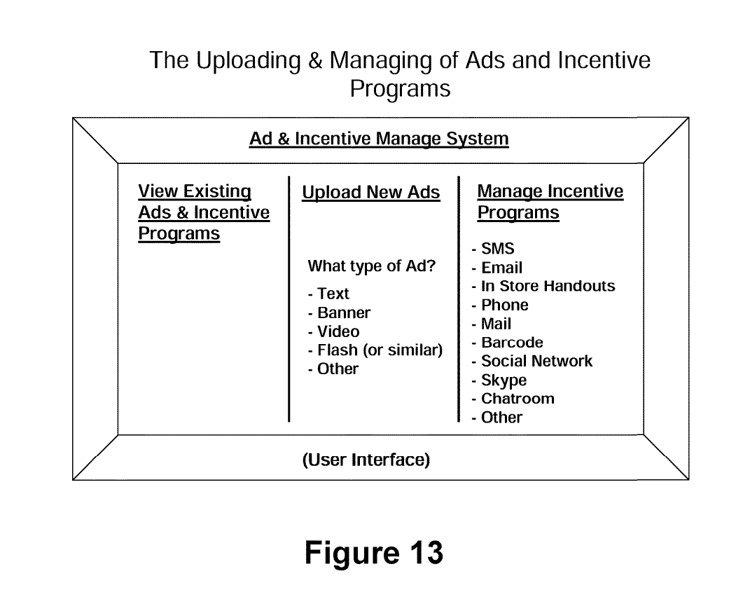

FIG. 13 shows an example graphical user interface for a system management application that will allow advertisers to load and manage advertisements and incentive programs that can be executed “downstream” with the help of the distributors.

A preferred embodiment for the disclosed method and apparatus herein, is for “appropriateness” checks to be made before ads and incentive programs are sent to the “downstream” distributors. Although advertisers would most likely send inappropriate content (and incentives) downstream deliberately, they may not know the rules, customs, and laws that prevail in a target region. Therefore, appropriateness checks can be made by the Content Owner(s), an ASP service, a third-party service, or others.

While all of the fundamental characteristics and features of the supply chain for physical media device and method have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A supply chain for physical media as shown in the drawings and described in the specification.
